(19) United States
(12) Patent Application Publication
(10) Pub. No.: US 2007/0101950 A1
(43) Pub. Date: May 10, 2007

(54) Pet training apparatus and methods of use

(76) Inventor: Ricky D. Medlin, Kempner, TX (US)

Correspondence Address: Charles Kulkarni;Jackson Walker L.L.P., Suite 2400, 112 E. Pecan Street, San Antonio, TX, 78205-1521, US

(21) Appl. No.: 11/589,597

(22) Filed: Oct. 30, 2006

Related U.S. Application Data
(60) Provisional application No. 60/735,037, filed on Nov. 9, 2005.

(51) Int. Cl. A01K 27/00

(52) U.S. Cl. 119/792

(57) ABSTRACT

The present invention provides a pet training device capable of conveying specific nonverbal commands from the user to the animal in an efficient manner. In one embodiment, the pet training device of the present invention utilizes a rigid, elongated member having a portion for grasping by the user. The elongated member may be attached to any conventional animal collar or chain via a snap, hook, clip, or other suitable attachment mechanism. Further, the portion for grasping by the user may contain an eyebolt or other suitable attachment device that may be used for attachment to the user's belt or other stable object. The rigid construction of the pet training device of the present invention allows the user to clearly nonverbally convey his or her intentions to the animal by moving the elongated member attached to the animal's collar or chain, allowing for efficient and effective animal training.

### CROSS-REFERENCE TO RELATED APPLICATION

This application claims priority from U.S. Application No. 60/735,037 filed Nov. 9, 2005, which is fully incorporated by reference as if it were fully printed herein.

### FIELD OF THE INVENTION

Applicant's invention relates generally to pet training devices and, more particularly, to a pet training apparatus capable of dramatically increasing the efficiency of pet training activities.

### BACKGROUND

The use of pet training devices is well known in the art. Many pet training devices, including collars, leashes and choke chains, have been utilized. Unfortunately, known designs fail to provide the user with sufficient control a pet's movement. For example, a choke chain allows the user to convey negative commands to the animal but does not allow for specific direction as to the relative position of the animal. Further, while conventional chain/leash arrangements allow the user to pull on the animal, they do not allow the user to positively exert control over the animal. As such, there remains a need for a pet training device capable of providing distinct, nonverbal commands to the pet during training.

### SUMMARY

In accordance with the present invention, a Pet Training Apparatus is provided, which substantially eliminates or reduces disadvantages and problems associated with previous systems and methods. The present invention provides a pet training device capable of conveying specific nonverbal commands from the user to the animal in an efficient manner. In one embodiment, the pet training device of the present invention utilizes a rigid, elongated member having a first and a second end; the first end having an attachment for releasably securing said first end to an animal; the second end being shaped to allow a portion for grasping by the user. More specifically, the first end of the elongated member may be attached to any conventional animal collar or chain via a snap, hook, clip, or other suitable attachment mechanism. Further, the second end of the elongated member may also include a hook, clip, snap, or other suitable attachment mechanism for attachment to the user's belt or other stable object. The rigid construction of the pet training device of the present invention allows the user to clearly convey his or her intentions as to the animal's behavior through movement of the elongated member attached to the animal's collar.

Another example of a pet training device to promote animal training, comprises a rigid elongated member having a first end and a second end; said first end comprising a first attachment member capable of releasably securing said first end to a pet restraint; and said second end adapted to be grasped by a user.

An example for a method for training an animal comprises the steps of: providing an animal training device comprising a rigid elongated member having a first end and a second end, a restraint worn by the animal, said first end comprising a first attachment member for releasably securing said first end to said restraint, and said second end adapted to be grasped by a user; attaching the pet training device to the animal; and directing the animal to remain stationary by holding the rigid elongated member so as to position the animal to heel next to the user.

The features and advantages of the present invention will be apparent to those skilled in the art. While numerous changes may be made by those skilled in the art, such changes are within the spirit of the invention.

### BRIEF DESCRIPTION OF THE DRAWINGS

For a more complete understanding of the present invention and the advantages thereof, reference is now made to the following description taken in conjunction with the accompanying drawings in which like reference numbers indicate like features, wherein:

FIG. 1A illustrates a pictorial representation of an embodiment of the present invention.

FIG. 1B illustrates various types of attachment devices capable of being used as part of the pet training device of the present invention.

FIG. 2 illustrates one embodiment of the present invention so that by holding the pet training device with both hands, one at the user's hip and the other at the user's chest, the user may effectively situate the animal into the heel position.

FIG. 3 illustrates one embodiment of the present invention wherein a pet training device is used to teach an animal to stay.

FIG. 4 illustrates one embodiment of the present invention wherein the pet training device is used in conjunction with a tool such as a foot so as to teach an animal to stay independent of the user's movements.

FIG. 5 illustrates one embodiment of the present invention showing the pet training device being used to teach an animal to come or to move toward the user upon a verbal command.

### DETAILED DESCRIPTION OF THE PREFERRED EMBODIMENT

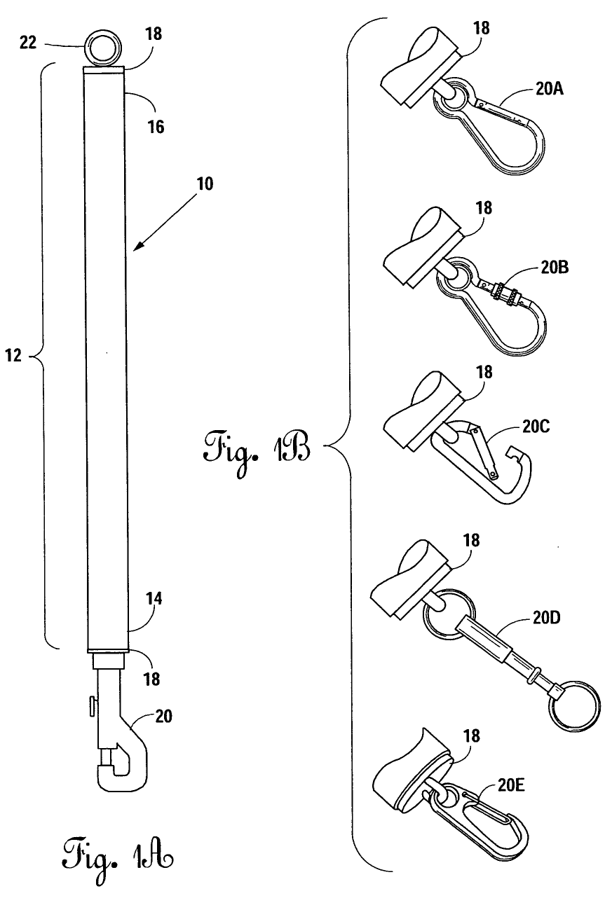

Referring to the figures, attention is directed to FIG. 1A, which illustrates a first embodiment of Applicant's pet training device (10). The present device (10) comprises a rigid elongated member (12), having a first end (14) for attachment to the animal's restraint such as a collar, a chain, a muzzle or a harness, and a second end (16) having a portion designed for grasping by the user. FIG. 1 depicts a rigid elongated member (12), comprising of a first end (14) and a second end (16); a plastic or metal cap (18) affixed on said first (14) and second end (16) of the elongated member (12); a suitable attachment device on said first end (20), such as a spring clip, trigger snap, eye hook, eye bolt snap, or other suitable attachment device as is well known in the art; and a securing device (22) on said second end (16). The second end (16) securing device (22) may be an eye bolt, a spring clip, trigger snap, eye hook, eye bolt snap, or other suitable attachment device as is well known in the art.

The rigid elongated member (12) of the present device (10) typically comprises a substantially cylindrical configuration, approximately three feet in length and about one inch in diameter. In certain embodiments, the rigid elongated member (12) may vary in length from about two feet to about 4 feet and may vary in diameter from about half and inch to about two inches. It should be noted that the elongated member (12) may be constructed of variable lengths, widths, and shapes in order to accommodate the greatest number of users and/or animals. Further, the rigid elongated member (12) comprises PVC plastic, fiberglass, plastic, metal, or combination thereof; yet, it should be understood that said elongated member (12) may be made of any substantially rigid material capable of allowing the user to transmit his or her nonverbal instructions to the animal. The rigid elongated member (12) may also include a cap (18) glued, or otherwise appropriately secured (e.g. screwed into or riveted to), at both the first end (14), and the second end (16) of the elongated member (12). Such caps (18) may be equipped with drill holes through which clips, eye bolts, snaps, hooks, etc., may be attached for various uses. Cap (18) may be made of any suitable material with sufficient integrity to withstand expected conditions of use including plastic, metal, wood, or a combination thereof.

In one embodiment, depicted in FIG. 1, said first end (14) of the elongated member (12) comprises an attachment device (20) for use in attaching the elongated member (12) to the animal's collar or chain. Further, said second end (16) of the elongated member (12) may be equipped with a securing device (22) which may be used to attach the elongated member (12) to the user's belt, a stable structure, or other foundation providing or securing attachment.

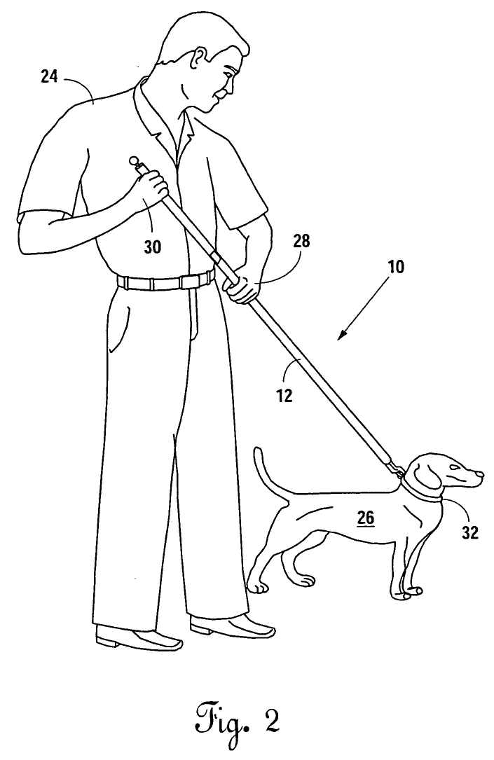

In one embodiment, the pet training device (10) may be utilized to teach an animal to sit, stay, and/or heel. Said teaching is accomplished by firmly directing the animal in the desired position with the elongated member (12) as seen in FIG. 2. In short, the use of a rigid elongated member (12) allows the user to, through movement of the elongated member (12), control and/or indicate the desired location to the animal. For example, to direct the animal to sit, the user would push in a downward direction on the elongated member (12) while, at the same time, gently pull in a rearward direction to encourage the animal to stop and sit.

FIG. 1B illustrates various types of attachment devices that may be used as part of the pet training device of the present invention. In particular, any of the following devices: spring clip (20A), spring clip with screw gate (20B), carabiner (20C), quick disconnect clip (20D), and snap closure strap (20E) may be used lieu of attachment device (20) of FIG. 1A or attachment device (18) of FIG. 1A.

FIG. 2 is a side view of one embodiment of the pet training device (10), showing a user/handler (24), an animal (26) in the proper heel position, and the pet training device (10). According to American Kennel Club® regulations, a dog in heel position should be at the handler's left side straight in line with the direction the handler is facing. The area from the dog's head to shoulder is to be in line with the handler's left hip. The dog should be close to, but not crowding the handler so that the handler has freedom of motion at all times. It is immediately evident that controlling all these aspects of an animal's (26) location relative to a handler (24) with a leash difficult, if not impossible but may be easily accomplished with the rigid training device (10).

As shown in FIG. 2, to instruct the animal (26) to heel in the correct position, the user (24) need only hold the elongated member (12) in front of his chest so as to place the animal (26) in the correct position alongside the user (24). This proper placement is accomplished by holding the pet training device (10) with both hands; the left hand (28) grasping the middle of the elongated member (12) or the first end (14) of the elongated member (12) and the right hand (30) grasping the second end (16) of the elongated member (12). As is seen, the attachment device (20) is secured to the animal (26) via attachment to a collar (32), as is known in the art. To ensure that the animal (26) is in the proper heel position, the left hand (28) is placed substantially next to user's left hip and the right hand (30) is placed substantially next to the right, upper side of the handler's chest. It will be appreciated that due to the varying sizes of animals (26) and handlers (24), the precise locations of the hands (28 and 30) relative to the handler (24) will vary. It is within the contemplation of the instant invention that the animal (26) may be instructed to heel on the handler's (24) right side, as well.

The heeling position of the animal, as depicted in FIG. 2, is of great importance for hunting dogs. During a hunt, it is important for the animal to remain on the non-gun side of the user to ensure collaboration between the user and the animal during the hunt. By providing a rigid elongated member (12), the present device (10) allows the handler (24) to place the animal in the optimum position at his or her non-gun side. In this manner, the animal (26) may be trained to maintain its position relative to the handler (24), even when the user is walking in small circles.

In one embodiment, as seen in FIG. 3, the pet training device (10) may also be utilized to teach the animal to stay, regardless of whether the animal is sitting or standing. For example, while giving a stay command to the animal, the user (24) may move away from the animal (26) while still maintaining a restraining force upon the animal via the rigid elongated member (12). In this manner, the present device (10) allows the user to nonverbally convey his or her desired position to the animal while, at the same time, speaking the correct command so that as a result, the animal receives both verbal and nonverbal commands at the same moment. This feature of the present device (10) greatly enhances the efficiency of the animal training exercise. Also seen in FIG. 3 is optional leash attachment (34), which is secured to the device (10) via securing device (22). Leash attachment (34) may be simply tied to securing device (22) or may be attached by any suitable attachment method known in the art, such as snaps, hooks, or clips.

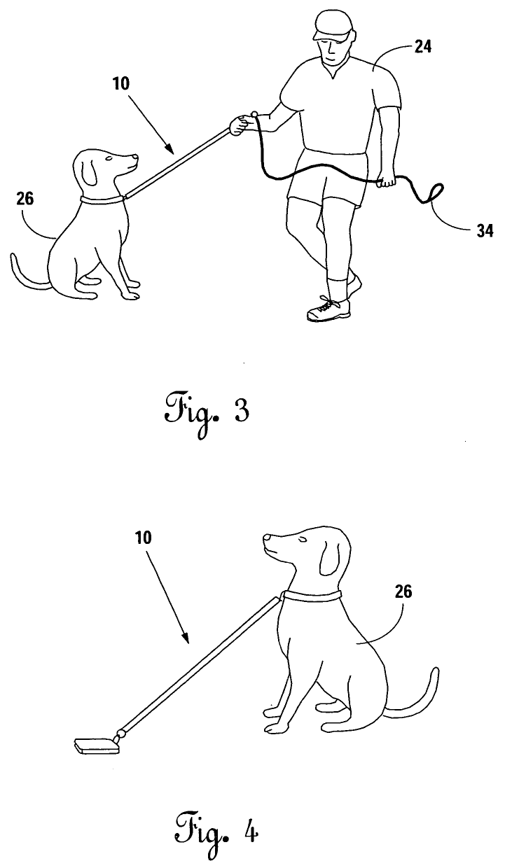

In addition to the above example, and as illustrated in FIG. 4, the user may utilize the device (10) to teach the animal to stay by placing the second end (16) of the elongated member (12) into the ground while leaving the attachment device (20) attached to the animal's (26) collar (32) and backing away from the animal (26). In this manner, the user can further encourage the animal to stay because the elongated member (12) is effectively “wedged” into the ground or floor, creating a restraining force against the animal's movement when it has been commanded to stay. Other attachments may be provided to the second end (16) of the elongated member (12) to further encourage this substantial benefit of the present device (10). For example, a foot (36), or other foundation providing device, may be attached to the second end (16) of the present device (10) via securing device (22) to provide a stable traction for the second end (16) of the elongated member (12) when placed against the ground or floor. The attachment of securing device (22) to foot (36) may be by any suitable attachment method known in the art such as clips, hooks, and snaps. The foot (36) is typically a block of wood or metal with an undulating base typically composed of rubber or other high friction material to engage the ground such as tile, concrete, or the like. In some embodiments, the base of the foot (34) may comprise spikes for engagement with soft ground. The foot (34) also comprises a hook or latch mechanism for attachment with securing device (22). It will be appreciated that foot (34) is not intended to prevent movement of the animal (26) but, rather, to discourage movement of the animal (26) until such movement is authorized by the user (24).

Turning now to FIG. 5, the benefits of the pet training device (10) may also be seen while teaching the animal (26) to “come,” or move toward the user (24) on verbal command. In this embodiment, a rope or leash (36) may be attached to an eye bolt or another securing device (22) located on the second end (16) of the elongated member (12). This second end (16) may then be lowered to the ground and released by the user as he/she backs away from the animal. The user may verbally and nonverbally reinforce the sit and/or stay commands while walking away from the animal, as shown above. The user (26) may then pull on the second end (16) via the rope or leash (36), dislodging the second end (16) of the elongated member (12) from the floor or ground, nonverbally reinforcing the verbal “come” command by gently pulling the animal in the direction of the user (26). In this manner, the present device (10) allows the user to teach the animal a multitude of commands in a very short period of time.

The present device (10) is further advantageous over prior inventions and methods of animal training because it is humane in its treatment of animals, and does not require the use of a choke chain, or other painful methods. For example, many training devices shock, pinch, or choke the animal while the user is attempting to train it. Leashes, while they are more humane, provide the user with little or no control over the behavior of the animal other than to keep the animal in the general vicinity of the user.

Although the present invention has been described with reference to specific embodiments, this description is not meant to be construed in a limited sense. Various modifications of the disclosed embodiments, as well as alternative embodiments of the device will become apparent to persons skilled in the art upon the reference to the description of the invention. It is, therefore, contemplated that the appended claims will cover such modifications that fall within the scope of the invention.

What is claimed is:

1. A pet training device to promote animal training, the pet training device comprising:
a rigid elongated member having a first end and a second end;
a restraint capable of being worn by a pet;
said first end comprising a first attachment member for releasably securing said first end to said restraint; and
said second end adapted to be grasped by a user.

2. The pet training device of claim 1 where said restraint is selected from one of a collar, a harness, a muzzle, and a lead.

3. The pet training device of claim 1 wherein said rigid elongated member is of substantially cylindrical configuration, and is between about 2 to 3 feet in length and between about 0.5 to 2 inches in diameter.

4. The pet training device of claim 3, wherein said rigid elongated member is composed of one of polyvinyl chloride (PVC), fiberglass, plastic, metal, or a combination thereof.

5. The pet training device of claim 3 wherein said rigid elongated member further comprises caps of metal or plastic, substantially conforming to the shape of said rigid elongated member, affixed at either end of said rigid elongated member.

6. The pet training device of claim 1 wherein said first attachment is a spring clip, a spring clip with screw gate, a carabiner, a quick disconnect clip, or a snap closure strap.

7. The pet training device of claim 6 wherein said second end further comprises a second attachment member.

8. The pet training device of claim 7 wherein said second attachment member is a spring clip, a spring clip with screw gate, a carabiner, a quick disconnect clip, or a snap closure strap.

9. The pet training device of claim 8 further comprising an arresting foot releasably attached to said second attachment member.

10. The pet training device of claim 8 further comprising a length of non-rigid pulling material releasably attached to said second attachment member.

11. The pet training device of claim 10 wherein said length of non-rigid pulling material is selected from one of a rope, a chain, a cable, and a leash.

12. The pet training device of claim 3 wherein said rigid elongated member is of substantially cylindrical configuration, and is about 3 feet long and about 1 inch in diameter.

13. A pet training device to promote animal training, the pet training device comprising:
a rigid elongated member having a first end and a second end;
said first end comprising a first attachment member capable of releasably securing said first end to a pet restraint; and
said second end adapted to be grasped by a user.

14. A method for training an animal comprising the steps of:
providing an animal training device comprising a rigid elongated member having a first end and a second end, a restraint worn by the animal, said first end comprising a first attachment member for releasably securing said first end to said restraint, and said second end adapted to be grasped by a user;
attaching the pet training device to the animal; and
directing the animal to remain stationary by holding the rigid elongated member so as to position the animal to heel next to the user.
